(19) United States
(12) Patent Application Publication
(10) Pub. No.: US 2013/0095300 A1
(43) Pub. Date: Apr. 18, 2013

(54) SELF-FUSING CARBON FIBER SILICONE TAPE AND MANUFACTURING PROCESS

(71) Applicants: Mark C. Hatje, Cheshire, CT (US); John Poplawski, (US)

(72) Inventors: Mark C. Hatje, Cheshire, CT (US); John Poplawski, (US)

(73) Assignee: THE MISDUN GROUP, INC., Southington, CT (US)

(21) Appl. No.: 13/273,405

(22) Filed: Oct. 14, 2011

(51) Int. Cl. B32B 3/00; B32B 5/02

(52) U.S. Cl. 428/189; 156/439; 156/177

(57) ABSTRACT

This invention relates to a tape product including two opposing elongated strips of silicone, and interposed therein a carbon fiber thread having a transverse spatial pattern such that the thread increases the tear resistance while maintaining the elastic limit of the strips of self-fusing tape.

### FIELD OF INVENTION

The present invention relates generally to self-fusing silicone tape for commercial and industrial applications.

### BACKGROUND

Self-fusing silicone rubber tape is a rubber-like material composed of silicone, a polymer, containing silicon together with carbon, hydrogen, and oxygen. These tape products are used in applications, such as civil engineering, military, aerospace, plumbing, construction and repair, where the need exists for tape solutions that are non-reactive, stable, and resistant to temperatures from 55° C. to +300° C. while maintaining its useful properties. Non-dyed silicone rubber tape with an iron-oxide additive (making the tape a red-orange color) is used extensively in aviation and aerospace wiring applications as a splice or wrapping tape due to its non-flammable nature. The iron-oxide additive adds high thermal conductivity but does not change the high electrical insulation property of the silicone rubber. This type of silicone tape self-fuses or amalgamates without any added adhesive.

Organic rubber has a carbon to carbon backbone which leaves them susceptible to ozone, UV, heat and other ageing factors that silicone rubber withstands well. At the extreme temperatures, the tensile strength, elongation, tear strength and compression set can be far superior to conventional rubbers although still low relative to other materials. However, compared to organic rubbers, silicone rubber tape has a very low tensile strength. For tape products that need to withstand even relatively low imposed loads, there is a need for a self-fusing tape that has a relatively high tensile strength. As used herein, the term “tensile strength” is a quantitative measure of the pulling force a certain length of tape can exert without breaking.” This definition of tensile strength must be contrasted from “modulus of elasticity.” The term “modulus of elasticity” as used herein means a measure of a tape's resistance to stretching, the higher the number the stiffer its resistance to stretching. In many silicone tape applications, the lack of a tape's resistance to stretching is preferred. Therefore, any improvement in a silicone tape, should strive to maintain the tape's maximally achievable modulus of elasticity and wherever possible improve the elastic limit, or yield strength, where a permanent deformation in a silicone tape will occur. Silicone tapes that resist tearing or have a high tear strength are also desirable in certain applications, and therefore any improvement in a silicone tape, should strive to maintain the tape's maximally achievable tear resistance. Carbon fiber is comprised of thin strands measuring between 0.005-0.010 mm in diameter and composed mostly of carbon atoms. The carbon atoms are bonded together in microscopic crystals that are more or less aligned parallel to the long axis of the fiber. The crystal alignment makes the fiber very strong for its size.

Notably several thousand carbon fibers twisted together form a thread or yarn, which is, as more fully described below, used in the invention herein to create a tape product that improves the tensile strength by embedding the carbon fibers between layer of self-fusing silicone tape, while keeping the “modulus of elasticity” unchanged from the silicone tape products that do not contain the feature of having embedded carbon fibers.

Additionally, high modulus carbon fibers as employed in the present invention have thermal conductivity several times higher than copper and are used for their thermal properties as well as high strength. During manufacture heat may be required to bond, fuse or vulcanize (to set or cure) the silicone into its rubber-like form. This is normally carried out in a two stage process at the point of manufacture into the desired shape, and then in a prolonged post-cure process. The inventors have developed a process for embedding carbon fibers between layers of self-fusing silicone tape that increases the tear resistance and insures that the elastic limit of the product is not exceeded.

### SUMMARY OF THE INVENTION

This invention relates to a self-fusing tape product including two opposing elongated strips of silicone rubber, and interposed therein a carbon fiber thread having a transverse spatial pattern such that the thread increases the tear resistance while maintaining the elastic limit of the tape product.

In another aspect of the invention a tape product manufacturing apparatus includes: a bobbin for the insertion of a spool having carbon thread for feeding a continuous strand of thread into an oscillating mechanism for moving the thread strand transverse to the motion of a top layer of silicone tape and the bottom layer of silicone tape that serves to encapsulate the carbon fiber thread to producing a desired pattern, each such spool of self-fusing silicon tape supplied by bobbins, whereby when the carbon thread is embedded between the layer of silicone tape a heat mechanism supplies the contact heat required to fuse the interior surfaces of the layer of silicone tape thereby encapsulating the carbon fiber thread.

Another embodiment of the invention includes a method of manufacturing silicone tape product that encapsulates the carbon fiber thread by providing an apparatus to embed a carbon thread between the two elongated strips of self-fusing silicone, oscillating carbon thread as it enters a nib in a pattern that increases the tear strength silicon tape product, heating the two elongated strips until the surfaces are permanently joined to encapsulate the carbon thread.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts, and wherein:

FIG. 1a is an end-view of the self-fusing tape with an embedded carbon fiber according to an embodiment of the present invention;

FIG. 1 b is a top sectional view A-A and end view of the self-fusing tape with an embedded carbon fiber according to an embodiment of the present invention;

FIG. 2 is a perspective view of the self-fusing tape with an embedded carbon fiber according to an embodiment of the present invention;

FIG. 3a-c, are cross sectional views A-A illustrating different patterns of carbon thread dependent on the tensile strength and modulus of elasticity desired self-fusing tape with an embedded carbon fiber according to embodiments of the present invention;

FIG. 4 is a is a perspective view of a manufacturing device for producing the self-fusing tape with an embedded carbon fiber according to an embodiment of the present invention.

### DETAILED DESCRIPTION

It is to be understood that the figures and descriptions of the present invention have been simplified to illustrate elements that are relevant for a clear understanding, while eliminating, for the purpose of clarity, many other elements found in the self-fusing tape with an embedded carbon fiber technology, methods of using the same and its manufacture. Those of ordinary skill in the art may recognize that other elements and/or steps may be desirable in implementing the present invention. However, because such elements and steps are well known in the art, and because they do not facilitate a better understanding of the present invention, a discussion of such elements and steps is not provided herein.

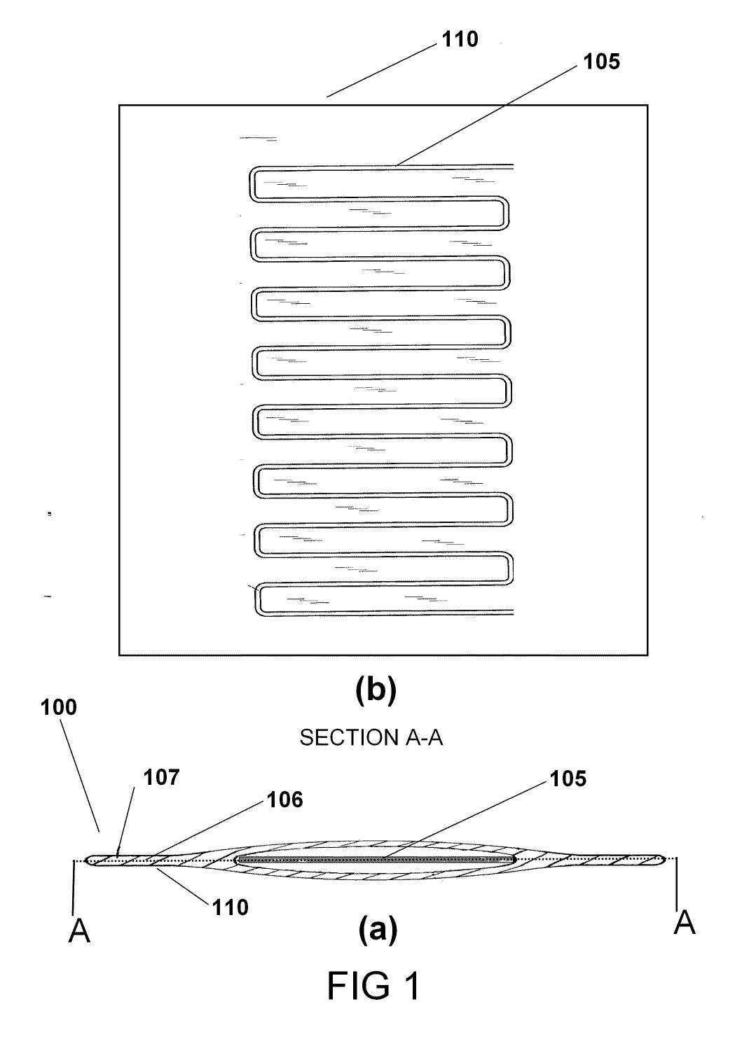

FIG. 1a illustrates one embodiment according to an embodiment of the present invention of a self-fusing tape 100 with an embedded carbon fiber 105. An elongated top layer of silicone tape 107 and a bottom layer of silicone tape 110 serve to encapsulate the carbon fiber thread 105. Various patterns of the thread, dependent on design factors, laid between the silicone tape layers, 107, 110 will serve to achieve a desired tensile strengths, increase tear resistance and preserve the elastic limit of the silicone elongated strips.

In FIG. 1b, a cross sectional view A-A illustration a pattern of straight horizontal lines progressing in fixed vertical steps. The steps may be any length, from a proximity where adjacent horizontal thread paths in a proximity that is indistinguishable to the human eye, or as shown in FIG. 1 b, where they are visibly separate, the proximity again satisfying a design choice dependent on the tensile strength and the elastic limit of the silicone tape.

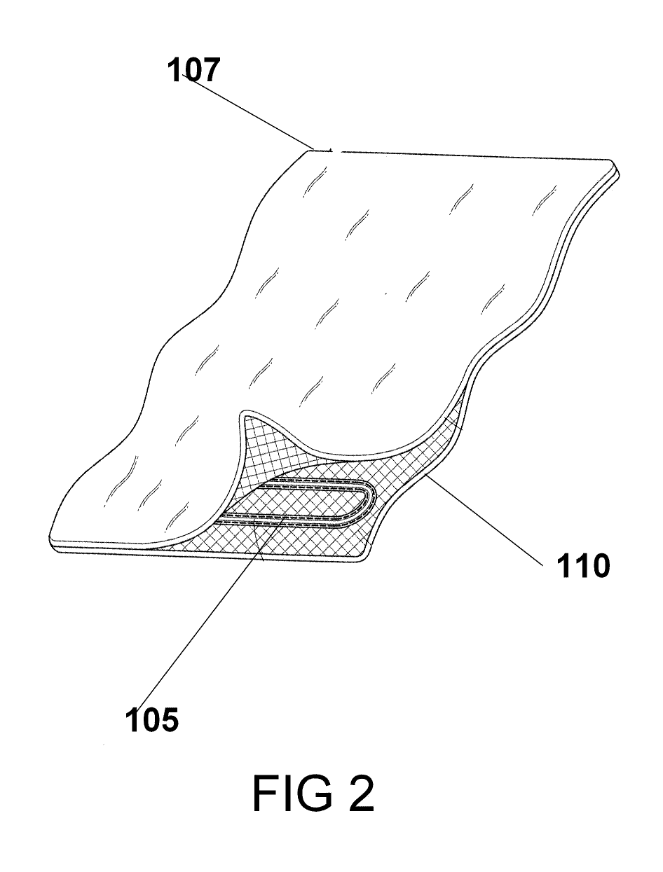

FIG. 2 is a perspective cut-away view according to an embodiment of the present invention of the self-fusing tape with an embedded carbon fiber showing the top layer of silicone tape 107 and the bottom layer of silicone tape 110 that serve to encapsulate the carbon fiber thread 105.

The invention relates to the tape product 100 including two opposing elongated strips of silicone rubber 107, 110, and interposed therein the carbon fiber thread 105 having a transverse spatial pattern such that the thread increases the tensile strength and increases the tear resistance while maintaining the elastic limit of the strips of self-fusing tape. The incorporation of the carbon fiber in itself increases the tear resistance of the product, since the carbon fiber thread 105 is virtually impossible to break.

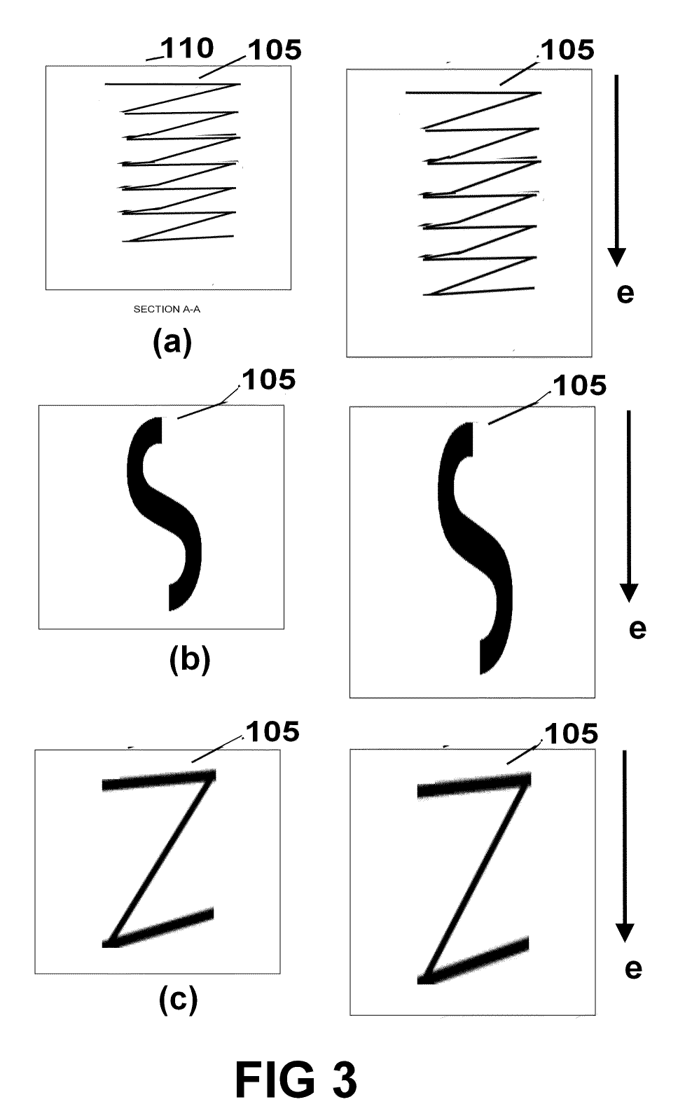

The embodiments shown as “5”, triangular or a “Z” pattern in FIG. 3a-c, are by way of example and not limitation, cross sectional views A-A illustrating different pattern of carbon thread 105 dependent on the desired tensile strength and modulus of elasticity. Corresponding to each sectional views A-A the tape 100 section A-A silicone member is shown stretched a distance e, which illustrates an increase in the tensile strength of the tape 100.

The self-fusing silicone tape 100 suitable for the top layer of silicone tape 107 and the bottom layer of silicone tape 110 meets the requirements of: operating at a continuous temperature between −64° C. to +260° C.; having a tensile strength of 700 psi minimum (ASTM-d-412 standard testing), thickness tolerances +/−,002″ width +/−0.0625″; ultimate elongation 300% minimum (ASTM d-412 standard testing); and a tear resistance 85 psi. A self-fusing silicone tape manufactured and sold under the registered trademark Tommy Tape, by Midsun Specialty Products, Berlin Conn. meets the aforementioned requirements of the elongated silicone self-fusing material. A carbon thread meeting the requirements for the invention may be purchases at: http://www.alibaba.com/product-gs/232371964/Carbon_Conductive_Thread.html.

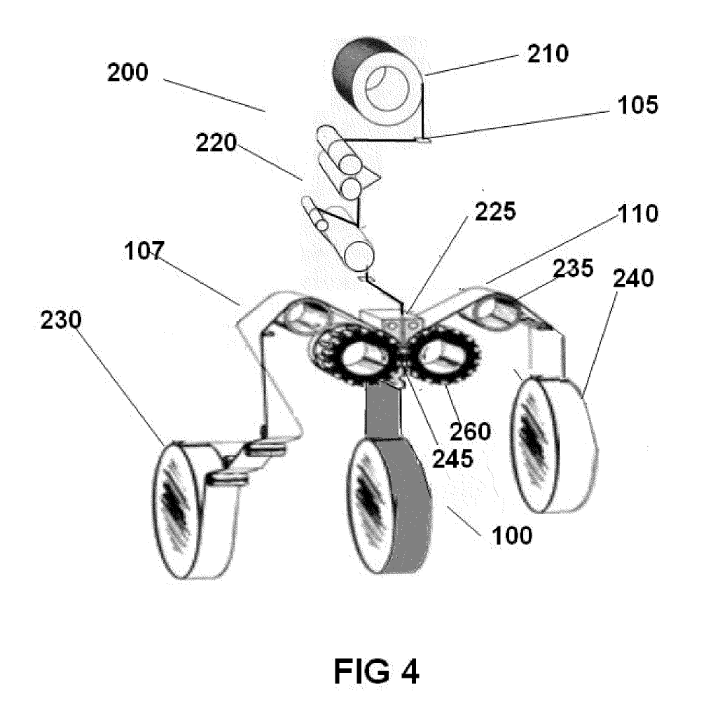

FIG. 4 is a is a perspective view of a manufacturing device for producing the self-fusing tape with an embedded carbon fiber according to an embodiment of the present invention. A spool of carbon thread 210 is installed on a bobbin that feeds a continuous strand of thread 215 through tension rollers 220 and into a mechanism 225 that oscillates or moves the thread strand 215 transverse to the motion of the top layer of silicone tape 107 and the bottom layer of silicone tape 110 that serve to encapsulate the carbon fiber thread 105 to produce the desired pattern. Devices to oscillate of thread to create the desired pattern are well known to those of ordinary skill in the art of mechanical engineering. A bobbin having a spool of self-fusing silicon tape 230 supplies the top layer 107 and a bobbin having a spool of self-fusing silicon tape 240 supplies the bottom layer 110, each such layer traveling over respective tension roller 235. Mechanism 260 supplies the contact heat required to fuse the surfaces where the interior surfaces of the layer of silicone tape 107 and the bottom layer of silicone tape 110 meet at a nib 245 where the carbon fiber thread 105 is encapsulated. For clarity the mechanisms required to move the supply of carbon thread and silicon tape are not shown, however, such mechanisms are well known to those of ordinary skill in the art of mechanical engineering.

A method of manufacturing silicone tape that encapsulates the carbon fiber thread includes providing a mechanism to embed a carbon thread between the two elongated strips of self-fusing silicone rubber tape, 107,110, oscillating the tape in a mechanism 225 in a pattern that insures the elastic limit of the elongates strips will not be exceeded, and the carbon thread 105 enters the nib 245 of the confluence between two opposing silicone tape 107, 110 interior surfaces, heating said tape surfaces until permanently joined to encapsulate the carbon thread.

While the present invention has been described with reference to the illustrative embodiments, this description is not intended to be construed in a limiting sense. Various modifications of the illustrative embodiments, as well as other embodiments of the invention, will be apparent to those skilled in the art on reference to this description. It is therefore contemplated that the appended claims will cover any such modifications or embodiments as fall within the true scope of the invention.

What is claimed is:

1. A tape product comprising: two opposing elongated strips of silicone rubber, and interposed therein a carbon fiber thread having a transverse spatial pattern such that the thread increases the tear resistance while insuring the elastic limit of the strips of tape is maintained.

2. The tape product claim 1, wherein the elongated strips of silicone produce a self-fusing tape.

3. The tape product claim 1, wherein the transverse spatial pattern is in the form of rectangular steps.

4. The tape product claim 1, wherein the transverse spatial pattern is in the form of triangular steps.

5. The tape product claim 1, wherein the transverse spatial pattern is in an “S” shape.

6. The tape product claim 1, wherein the transverse spatial pattern is in the form of rectangular steps.

7. The tape product claim 1, wherein the transverse spatial pattern is in an “Z” shape.

8. The tape product claim 1, wherein the silicone rubber operates at a continuous temperature between −64° C. to +260° C.

9. The tape product claim 1, wherein the silicone rubber has a tensile strength exceeding 700 psi.

10. The tape product claim 1, wherein the silicone rubber has an ultimate elongation of 300% minimum.

11. The tape product claim 1, wherein the silicone rubber has a minimum tear resistance 85 psi.

12. A tape product manufacturing apparatus comprising: a bobbin for the insertion of a spool having carbon thread for feeding a continuous strand of thread into an oscillating mechanism for moving the thread strand transverse to the motion of a top layer of silicone tape and the bottom layer of silicone tape that serve to encapsulate the carbon fiber thread and for producing a desired spatial pattern that increases the tear resistance of the tape product while insuring the elastic limit of the strips of the tape is maintained, each such spool of silicon tape supplied by bobbins, whereby when the carbon thread is embedded between the layers of silicone tape a heat mechanism supplies a contact heat required to fuse the interior surfaces of the layer of silicone tape thereby encapsulating the carbon fiber thread.

13. A method of manufacturing silicone tape product that encapsulates the carbon fiber thread comprises: providing an apparatus to embed a carbon thread between the two elongated strips of self-fusing silicone rubber tape, oscillating carbon thread as it enters a nib in a pattern that increases the tear resistance while insuring the elastic limit of the strips tape is maintained, heating the two elongated strips until the surfaces are permanently joined to encapsulate the carbon thread.
